(19) United States
(12) Patent Application Publication
(10) Pub. No.: US 2015/0264009 A1
(43) Pub. Date: Sep. 17, 2015

(54) CLIENT-SELECTABLE ROUTING USING DNS REQUESTS

(71) Applicant: LIMELIGHT NETWORKS, INC., Tempe, AZ (US)

(72) Inventor: John Scharber, Placerville, CA (US)

(73) Assignee: LIMELIGHT NETWORKS, INC., Tempe, AZ (US)

(21) Appl. No.: 14/602,923

(22) Filed: Jan. 22, 2015

Related U.S. Application Data
(60) Provisional application No. 61/930,373, filed on Jan. 22, 2014.

(51) Int. Cl. H04L 29/12; H04L 12/879

(52) U.S. Cl. CPC H04L 61/2007; H04L 61/1511; H04L 49/901

(57) ABSTRACT

This disclosure provides for passing policies in a DNS record (e.g., NAPTR record) that allows a client to make decisions, such as on network paths, servers to request content from, and/or protocols to use. In some embodiments, the client makes the decisions at the application level. And in some embodiments, the client is another server in a CDN.

### CROSS-REFERENCE TO RELATED APPLICATION

This application claims the benefit of Provisional Application No. 61/930,373, filed Jan. 22, 2014, and entitled “Client-selectable routing using DNS requests”; the above-identified application is incorporated by reference herein, in its entirety, for all purposes.

### DISCLOSURE

This disclosure relates in general to domain name service (DNS) system over the Internet, and, but not by way of limitation, to DNS service within a content delivery network (CDN) amongst other things.

Content delivery networks (CDNs) have a geographically distributed network of points of presence (POPs) such that one is likely to be close to an end-user system. A request for content is matched to a nearby POP using routing, DNS diversion, redirection, Anycast, and/or other techniques. An edge server in the POP generally serves the content from a cache of the edge server, a host within the CDN, or an origin server depending on where the content is located. The process of caching, routing, and redirecting the request can be time consuming. Moreover, for content that is missing from the CDN, the request to the origin server can be costly in terms of quality of service.

### SUMMARY

This disclosure provides for passing policies in a DNS record (e.g., NAPTR record) that allows a client to make decisions, such as on network paths, servers to request content from, and/or protocols to use. In some embodiments, the client makes the decisions at the application level. And in some embodiments, the client is another server in a CDN.

### BRIEF DESCRIPTION OF THE DRAWINGS

The present disclosure is described in conjunction with the appended figures:

FIG. 1 is a block diagram of an embodiment of a content distribution system;

FIG. 2 is a block diagram of an embodiment of a CDN;

FIG. 3 is a block diagram of an embodiment of a cooperative delivery system;

FIG. 4A depicts a block diagram of a POP;

FIG. 4B depicts a block diagram of an embodiment for updating a rules repository a domain name system (DNS);

FIG. 5 is a flowchart of a method for updating a DNS for individual content object;

FIG. 6 depicts the entire system from content provider to end user;

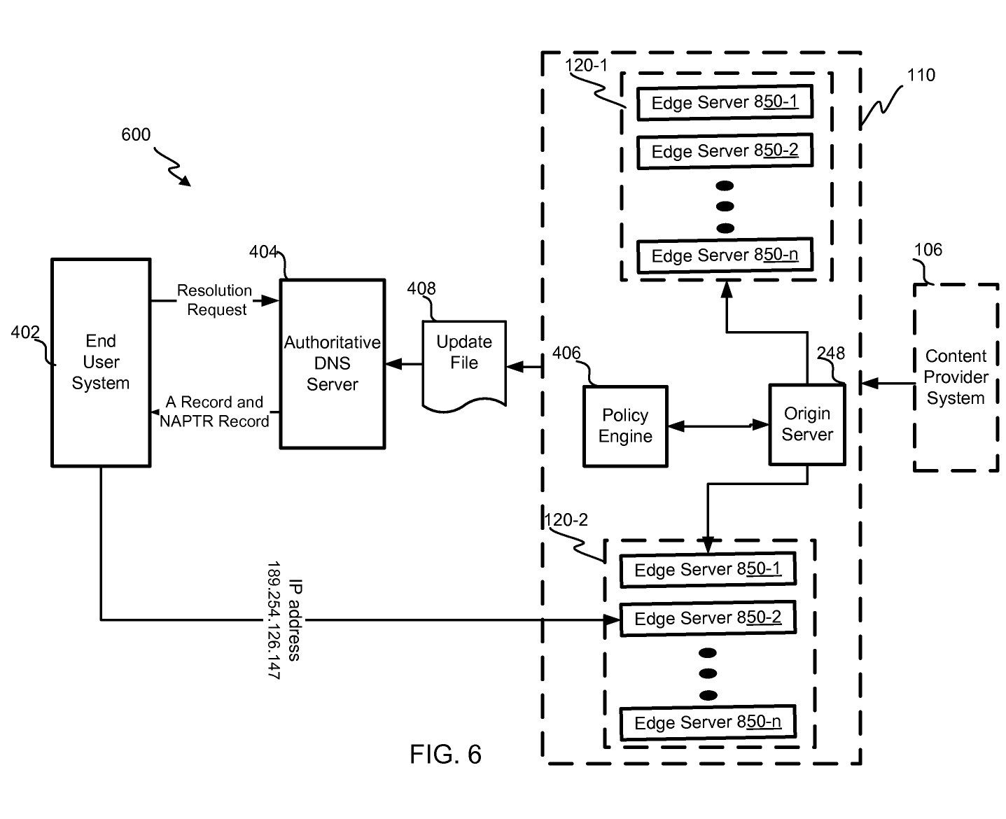

FIG. 7 shows how the end user request is filled;

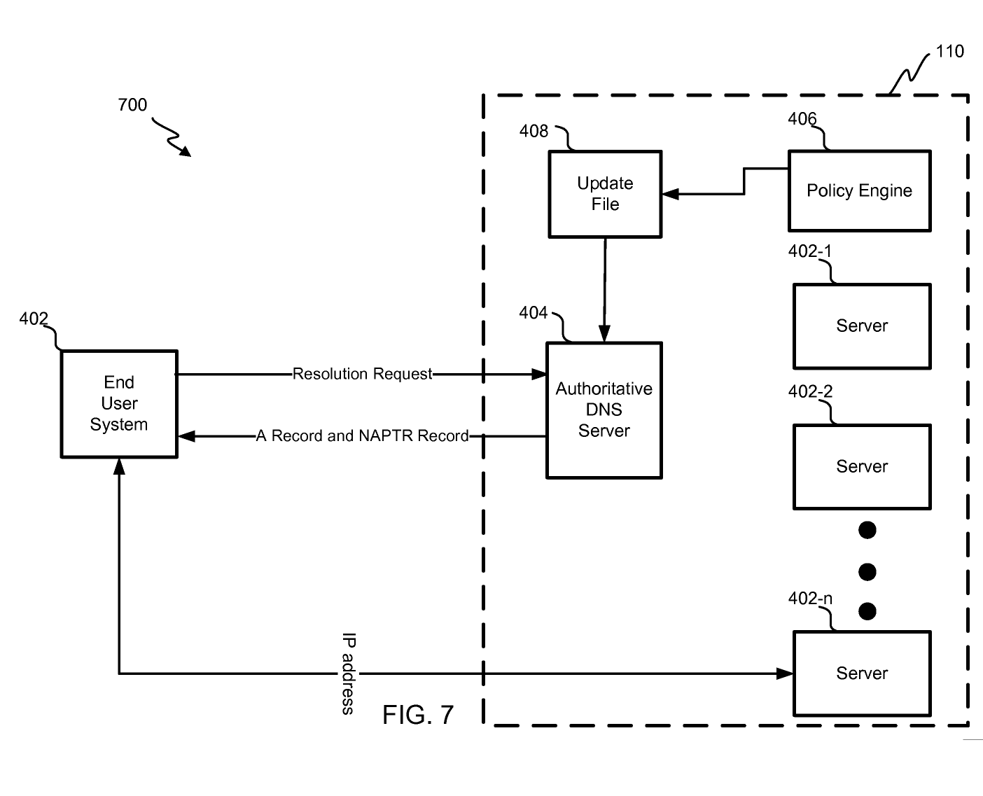

FIG. 8 depicts the computer implemented user request chart:

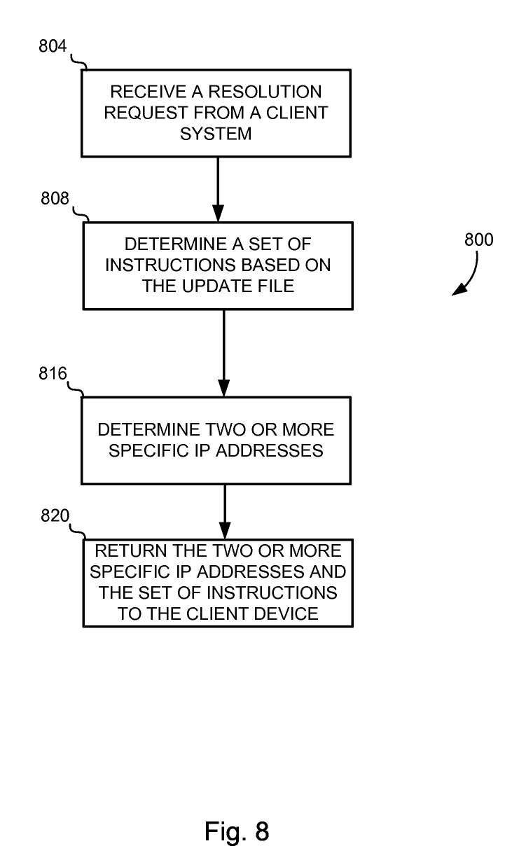

FIG. 9 is the overall depiction of the federated CDN;

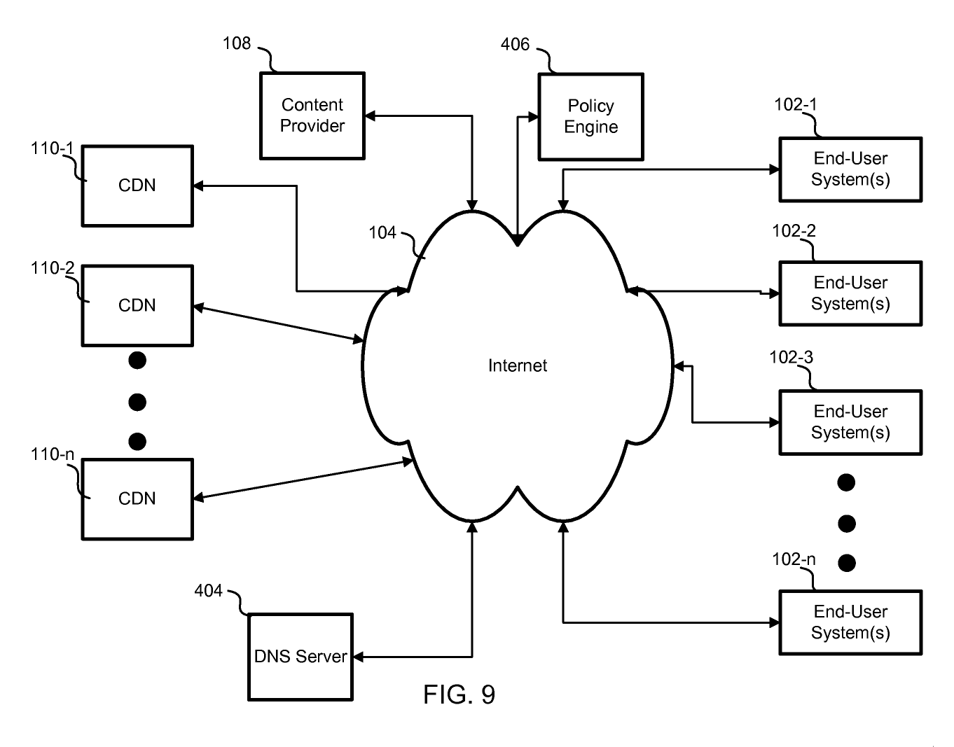

FIG. 10 is an exemplary environment with which embodiments may be implemented with a computer system;

FIG. 11 is a computer-program products that direct a computer system to perform the actions;

FIG. 12 is a block diagram of a federated CDN system.

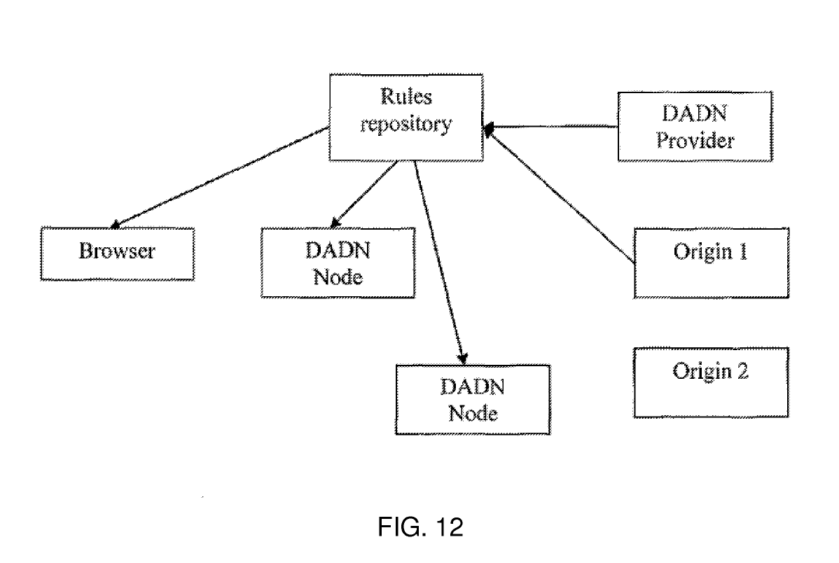

### DYNAMIC APPLICATION DELIVERY NETWORK (DADN)

The following describes a method for dynamically constructing an Application Delivery Network in a standalone or federated environment. An embodiment of the system has a browser, rules repository, and one or more DADN nodes.

### Browser

In some embodiments, the browser is a standard browser such as Internet Explorer or Chrome. In some embodiments, the browser is an enhanced version. Enhanced versions can query the Rules Repository and discover optimal DADN nodes that are optimal for them including the current geographical location, applications capabilities, and current network topologies.

### Rules Repository

In some embodiments, the rules repository is a DNS server that supports Named Authority

Pointers (NAPTR records). NAPTR resource records support a dynamic delegation based on one or more variables. In some embodiments, delegation is made to a customer origin, DADN provider or Federated partner based on business, state or application level attributes.

One example of how this might work is in CCN or cellular network where a mobile user is moving between multiple points of service and has multiple service options (like paid vs free) that include multiple service providers. In such a case the user could automatically discover those choices, select an option manually or by stored preference and even be passed back the proper configuration information such as wireless keys.

### DADN Node

A DADN node maintains a list of origins and other DADN nodes along with the associated network distance, application distance, dollar cost, protocol and availability collectively these attributes are referred to as Network Cost (NC) and can be weighted using any number of techniques. The technique to be applied can also be defined in the rules repository. In some embodiments, a DADN node is an authoritative DNS server. In some embodiments, a DADN node is an edge server in a CDN.

When a new request is received, the DADN node queries its internal list to see if it has an origin list or DADN peer list to which the request should be forwarded. If no information is found the request is handled as a standard proxy request and a Rules Repository request is executed and the results added to its internal lists. Note that results could be positive or negative where negative means there is no Rules Repository data. This information would be cached to avoid further looks for a TTL configured by the DADN operator.

If a list match is found, the DADN node selects either the origin (possibly having many choices) or DADN peer that has the lowest NC. This may further be tuned by ignoring options whose NC is beyond a threshold N avoiding the need to maintain performance information about possibilities that would never be selected. The DADN request is then sent to the selected node caring information such as hop counts and previous hops to prevent loop detection and optimize performance. For example forwarding no more than 2 hops in North America.

After the initial request is received statistics are updated based on real traffic and the NC is recomputed every Delta Time Active (5 seconds) for active choices or Delta Time In Active (60 seconds) for quiescent nodes. Since results from the Rules Repository can be cached, any active choice should be refreshed by a request handler (I.E. HTTP GET) when it falls below 10% (configurable) of its TTL.

Inactive choices are queried every N seconds to determine availability and NC. N is determined by the NC, choices that have a close NC are quarried more frequently than NC that have a high NC. High cost NC's are still queried because they may become a better choice is there is a local or regional failure.

In some embodiments, since DADN nodes use a hop-by-hop request routing technique with dynamic discover of origins and nodes they present a scalable architecture.

### Additional Examples

In some embodiments, a client makes a DNS request to resolve a URL. A DNS server (e.g., DADN node and/or the rules repository) provides a DNS response to the DNS request. The DNS response has an address record (e.g., A record and/or AAAA record)with an IP address. Additionally, the DNS response has data and/or logic provided in a named authority pointer record (NAPTR). For example, logic provided in a NAPTR record instructs the client to use a second IP address, provided in the NAPTR record, if a server corresponding to the IP address in the A record was responding slowly. This could be based on client timeout. The second IP address identifies a second server. In some embodiments, the second server is in a different node path, but same destination. In some embodiments, the second server is a different destination (i.e., serves the same or different content object) or a different server to server the content from. In some embodiments several additional servers are provided for in the NAPTR record.

In some embodiments, different POPs of a CDN are provided for fallback in the NAPTR record. For example, if servers in a New York POP were underperforming, the client could be directed to a POP in Miami. In some embodiments, a protocol fallback is provided. For example, a client is instructed to connect with a server using HLS (HTTP Live Streaming), then to a server using RSTP, then to a server providing MPEG4. The servers could all be in the same POP or in different POPs. The servers could be the same server, just using different protocols.

In some embodiments, fallbacks are given to different CDNs. For example, the client is given an IP address in an A record to a first CDN. A NAPTR records provides a time out so (e.g., 1, 2, 3, or 4 second) where if the first CDN does not respond, the client makes a request to a second CDN for the content object.

In some embodiments, the client decides on a protocol to use. For example, a In another example, the client chooses an ad server. In the NAPTR record, the client is given several ad servers to attempt. In some embodiments, the client is instructed to use a particular ad server if the client shares information with the ad server. For example, if a client is an iPhone and shares location information of the iPhone, the client selects ad service A over ad service B. But if location sharing is turned off, the client selects ad service B over ad service A. In some embodiments, the client is instructed to simply select ad service A, then ad service B, then ad service C, etc.

In some embodiments, preferences and sub-preferences are provided. For example, the client is directed to POP A then POP B and then POP C. But within POP A, the client is to try server 122.543.2.3 first if the client has HLS capabilities.

In some embodiments, the process is recursive. For example, in response to a first DNS request the client is directed to a first CDN then a second CDN if the first CDN does not respond within a given time. The client makes a second DNS request, the second DNS request going to the first CDN. The first CDN reads the URL and/or header(s) in the request and provides the client with several different servers to fallback to, including a server in the second CDN.

In some embodiments, an enhanced DNS service is provided that allows sending more bytes and/or adds security (such as encryption). For example, servers in a CDN could communicate with each other using the enhanced DNS. In some embodiments, the client is a server in a CDN.

In some embodiments, a shim is added to the client that allows the client to interpret and use the NAPTR records in ways described in this disclosure. In some embodiments, an operating system of the client has code for using the NAPTR records.

It should be understood that the disclosure and specific examples, while indicating various embodiments, are intended for purposes of illustration only and are not intended to necessarily limit the scope of the disclosure.

The disclosure provides preferred exemplary embodiment(s), and is not intended to limit the scope, applicability, or configuration of the disclosure. Rather, the disclosure of the exemplary embodiment(s) provides those skilled in the art with an enabling disclosure for implementing a preferred exemplary embodiment. It is understood that various changes may be made in the function and arrangement of elements without departing from the spirit and scope as set forth in the appended claims.

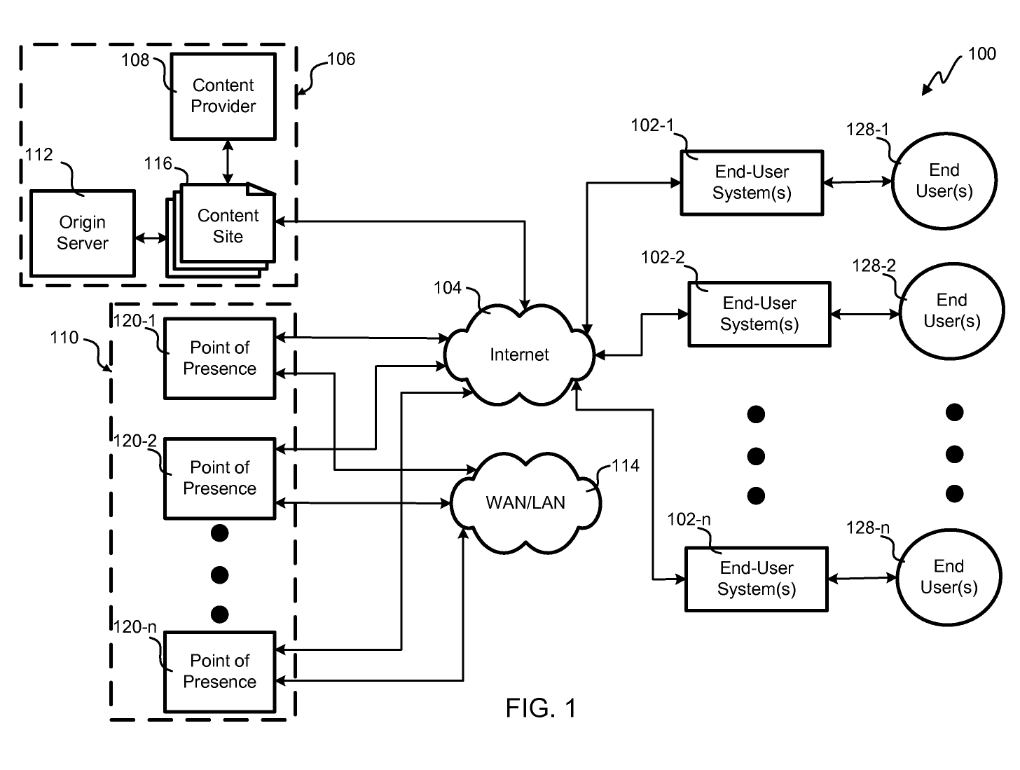

Referring first to FIG. 1, a block diagram of an embodiment of a content distribution system 100 is shown. The content originator 106 offloads delivery of the content objects to a content delivery network (CDN) 110. The content originator 106 produces and/or distributes content objects and includes a content provider 108, a content site 116, and an origin server 112. The CDN 110 can both cache and/or host content in various embodiments for third parties to offload delivery and typically provide better quality of service (QoS) to a broad spectrum of end-user systems 102 distributed geographically. The content originator 106 is the customer of the CDN 110 and an end user 128 benefits from improvements in QoS.

In this embodiment, the content distribution system 100 locates the content objects (or portions thereof) and distributes the content objects to an end-user system 102. The content objects are dynamically cached within the CDN 110 and/or hosted by the CDN 110. A content object is any content file, content stream, or a range defining a segment of a content file or content stream, and could include, for example, video, pictures, data, audio, software, and/or text. The content object could be live, delayed, or stored. The range defining a segment could be defined as a byte range or time range within the playback. Throughout the specification, references may be made to a content object, content, content stream and/or content file, but it is to be understood that those terms could be used interchangeably wherever they may appear.

Many content providers 108 use a CDN 110 (or multiple CDNs) to deliver the content objects over the Internet 104 to end users 128. The CDN 110 includes a number of points of presence (POPs) 120, which are geographically distributed through the content distribution system 100 to deliver content. Various embodiments may have any number of POPs 120 within the CDN 110 that are generally distributed in various locations around the Internet 104 so as to be proximate to end-user systems 102. Multiple POPs 120 use the same IP address such that an Anycast routing scheme is used to find a POP likely to be close to the end-user system 102, in a network sense, for each request. In addition to the Internet 104, a wide area network (WAN) and/or local area network (LAN) 114 or other backbone may couple the POPs 120 with each other and also couple the POPs 120 with other parts of the CDN 110. Distributed storage, processing, and caching is provided by the CDN 110.

When an end user 128 requests a web page (or other content) through its respective end-user system 102, the request for the web page is passed either directly or indirectly via the Internet 104 to the content originator 106. The content originator 106 is the source or re-distributor of content objects, i.e., the so-called origin server 112. The content site 116 is an Internet web site accessible by the end-user system 102. In one embodiment, the content site 116 could be a web site where the content is viewable with a web browser. In other embodiments, the content site 116 could be accessible with application software other than a web browser. The content provider 108 directs content requests to a CDN 110 after they are made or formulates the delivery path by embedding the delivery path into a uniform resource identifier (URI) for a web page. In any event, the request for content is handed over to the CDN 110 in this embodiment by using an Anycast IP address corresponding to two or more POPs 120. In some embodiments, the CDN 110 hosts content objects and/or web pages, thus acting as the origin server 112.

Once the request for a content object is passed to the CDN 110, the request is associated with a particular POP 120 within the CDN 110 using the Anycast routing scheme, but other embodiments could use routing, redirection, or DNS to shunt requests to a particular POP 120. It is noted that the CDN 110 processes requests for content in the application layer of the open systems interconnection (OSI) model with URIs, URLs, and HTTP. The particular POP 120 may retrieve the portion of the content object from the content provider 108, where the content originator 106 is hosting the origin server 112. Alternatively, the content provider 108 may directly provide the content object to the CDN 110 and POPs 120 associated with the CDN 110 through pre-population of caches (i.e., in advance of the first request) or hosting. A storage policy could be defined to specify the conditions under which pre-population is performed. In this embodiment, content objects are provided to the CDN 110 and stored in one or more CDN servers such that the portion of the requested content may be hosted from the CDN 110. The CDN servers include edge servers in each POP 120 that serve end-user requests. The origin server 112 holds a copy of each content object for the content originator 106. Periodically, the content of the origin server 112 may be reconciled with the CDN 110 through a caching, hosting, and/or pre-population algorithm, for example, through a storage policy. Some content providers 108 could use an origin server 112 within the CDN 110 to host the content and avoid the need to maintain a copy.

Once the content object is retrieved, the content object is stored within the particular POP 120 and is served from that POP to the end-user system 102. The end-user system 102 receives the content object and processes the content object for use by the end user 128. The end-user system 102 could be a personal computer, media player, handheld computer, tablet, pad, Internet appliance, phone, smart phone, IPTV set top, streaming radio, or any other device that receives and plays content objects. In some embodiments, a number of the end-user systems 102 could be networked together. Although this embodiment shows only a single content originator 106 and a single CDN 110, it is to be understood that there could be many of each in various embodiments.

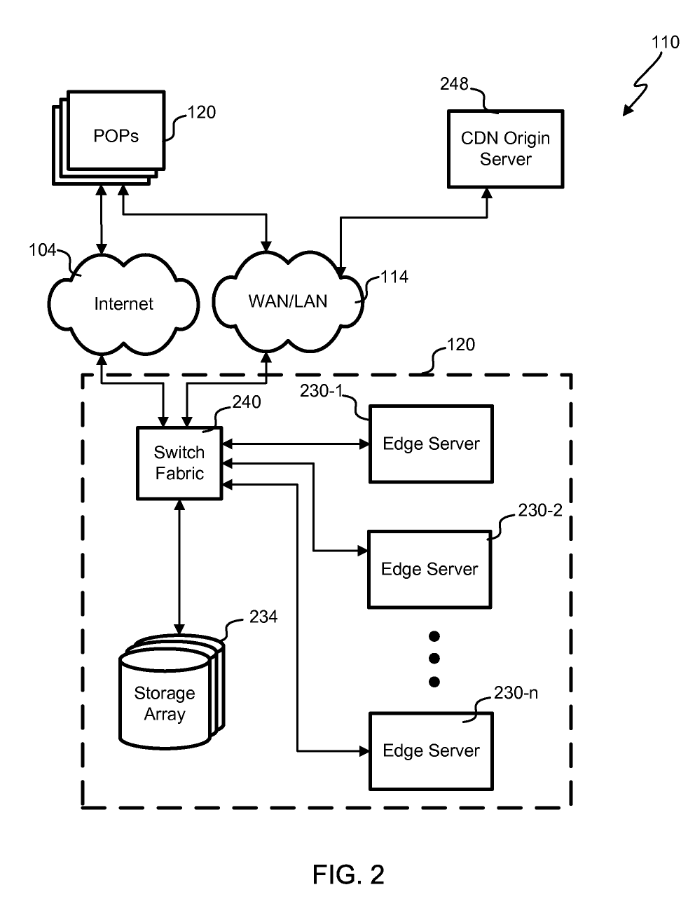

With reference to FIG. 2, a block diagram of an embodiment of a CDN 110 is shown. Although only one POP 120 is shown in detail, there are a number of POPs 120 similarly configured throughout the CDN 110. The POPs 120 communicate through a WAN/LAN 114 and/or the Internet 104 when locating content objects. An interface from the Internet 104 to the POP 120 accepts requests for content objects from end-user systems 102. The requests come from an Internet protocol (IP) address of the end-user system 102 in the form of a URI that causes an HTTP get command. The requests for content files from the CDN 110 pass through the application layer.

Switch fabric 240 assigns the request to one of the edge servers 230 according to a routing scheme such as round robin, load balancing, etc. In some embodiments, the switch fabric 240 is aware of which edge servers 230 have what capabilities and assigns requests within the group having the capability to store and serve the particular content object referenced in the URI. Edge servers 230 gathered in a particular group as neighbors can be grouped with other servers in the current POP 120, less loaded servers in the current POP 120, servers having a capability to process the content object, a subset of servers assigned to a customer using the CDN 110 to serve the content object, or some other grouping of servers in the POP 120.

In some cases, the CDN 110 is used to host content for others. Content providers 108 upload content to a CDN origin server 248. Although only one CDN origin server 248 is shown, it is to be understood that there could be many spread among a number of locations and/or POPs 120. The content object can be stored in the CDN origin server 248. The CDN origin server 248 serves the content object within the CDN 110 to various edge servers 230 in various POPs 120. After the content provider 108 places a content object on the CDN origin server 248 the content object need not be hosted on an origin server 112 of the content originator 106 redundantly. Although shown separately, it is to be understood that the CDN origin sever 248 could be integral to an edge server 230.

Some embodiments include an optional storage array 234 in the POP 120 or elsewhere in the CDN 110. The storage array 234 can provide hosting, storage, and/or caching. Edge servers 230 can revert to the storage array 234 for certain content, for example, very large files or infrequently requested files. Flushing of a cache of an edge server 230 could move the content to the storage array 234 until it is ultimately flushed from the storage array 234 after which subsequent requests would be fulfilled by an origin server 112 to repopulate cache in the POP 120.

Requests from end-user systems 102 are assigned to an edge server 230 that may cache, store, or host the requested content object. At times, the edge server 230 receiving a request does not have the content object stored for immediate serving. This so-called “cache miss” triggers a process within the CDN 110 to find the content object (or portion thereof). The content may be found in neighboring edge servers 230 in the same POP 120, in another POP 120, in a CDN origin server 248, in a POP storage array 234, or even an origin server 112 external to the CDN 110. The various edge servers 230 and CDN origin servers 248 are grouped for various URIs uniquely. In other words, one URI may look to one group of servers 230, 248 on a cache miss while another URI will look to a different group of servers 230, 248.

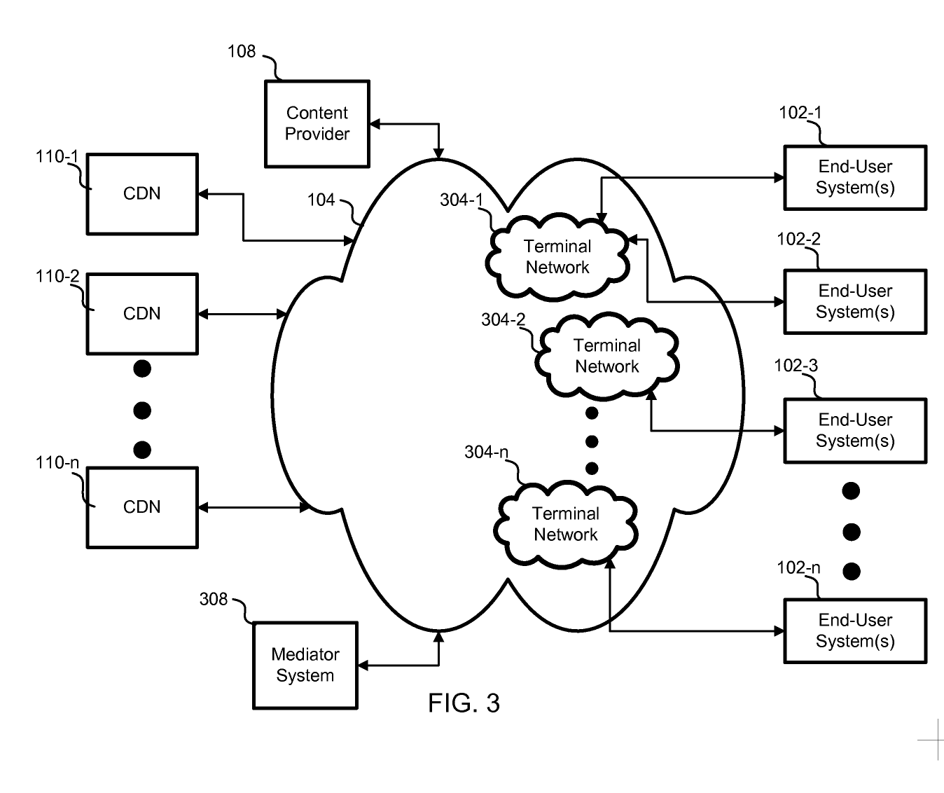

Referring next to FIG. 3, an embodiment of a cooperative delivery system is shown. A content provider 108 is connected to the Internet 104. Also connected to the Internet 104 are a plurality of CDNs 110 and a plurality of end-user systems 102. As part of the Internet 104, a plurality of terminal networks 304 provide internet service to the plurality of end-user systems 102. In some embodiments, terminal networks 304 are “last mile” networks providing telecommunications, cable television, and/or Internet services to end users 128. Some examples of terminal networks 304 include CenturyLink, Comcast, Verizon, and AT&T. In some embodiments, terminal networks 304 include peer networks. In some embodiments, terminal networks 304 have caches to store content objects. Caches of the terminal networks 304 can be a single cache, or spread out among a plurality of caches similar to a CDN 110 with a plurality of POPs 120. Some terminal networks 304 function as a content delivery network 110.

In this embodiment, the content provider 108 contracts with a first CDN 110-1 for delivery of a content object to end-user systems 102. Though only one content provider 108 is shown, there may be many content providers 108 contracting with CDNs 110 and/or terminal networks 304 for delivery of a plurality of content objects. Also, an origin server 112 having the content object can be external to the CDN 110 or internal to the CDN 110, such as in a CDN origin server 248. In some embodiments, the first CDN 110-1 subcontracts delivery of the content object to a second CDN 110-2 and/or terminal network 304 for delivery to an end-user system 102. The first CDN 110-1 may subcontract delivery of the content object for various reasons. For example, the second CDN 110-2 may have a better coverage of POPs 120 in a given geographic area. The first CDN 110-1 may have several POPs 120 in North America and Europe, but not South America. The second CDN 110-2 may have several POPs 120 in South America. To deliver the content object to an end user 128 in South America, the first CDN 110-1 subcontracts delivery of the content object to the second CDN 110-2. In another example, the second CDN 110-2 also has POPs 120 in Europe. When POPs 120 of the first CDN 110-1 in Europe become overloaded, the first CDN 110-1 has the second CDN 110-2 deliver the content object in Europe.

In some embodiments, the first CDN 110-1 subcontracts delivery of the content object with terminal networks 304. For example, the first terminal network 304-1 caches the content object when delivering the content object to a first end-user system 102-1. When a second end-user system 102-2 requests the content object, the first terminal network 304-1 serves the content object from a cache of the first terminal network 304-1.

In some embodiments, a mediator system 308 is also connected to the Internet 104. The mediator system 308 serves several functions for the cooperative delivery system, such as assignment, accounting, and control. In some embodiments, the mediator system 308 receives requests for delivery of the content object and assigns a CDN 110 or a terminal network 304 to deliver the content object. The mediator system 308 chooses a CDN 110 or terminal network 304 based on geography, latency in a network, delivery cost, quality of service, etc. In some embodiments, the mediator system 308 contracts with the content provider 108 for delivery of the content object instead of the first CDN 110-1 contracting with the content provider 108 for delivery of the content object. In some embodiments, the mediator system 308 is part of, and/or controlled by, a CDN 110 or terminal network 304. Also, a cooperative delivery system may comprise two or more mediator systems 308, and each mediator systems 308 is tied to a particular CDN 110.

In some embodiments, the mediator system 308 accounts for content delivery. After assigning delivery of the content object to a CDN 110 or terminal network 304, the mediator system 308 credits that network with delivery of the content object. In other embodiments, the mediator system 308 receives reports about delivery of the content object before crediting the CDN 110 or terminal network 304 for delivery.

In some embodiments, the mediator system 308 also establishes control parameters for delivery of the content object. For example, the content provider 108 sets a minimum quality of service threshold for delivering the content object. When assigning delivery of the content object, the mediator system 308 passes variables specifying the control parameters to the CDN 110 and/or terminal network 304 delivering the content object.

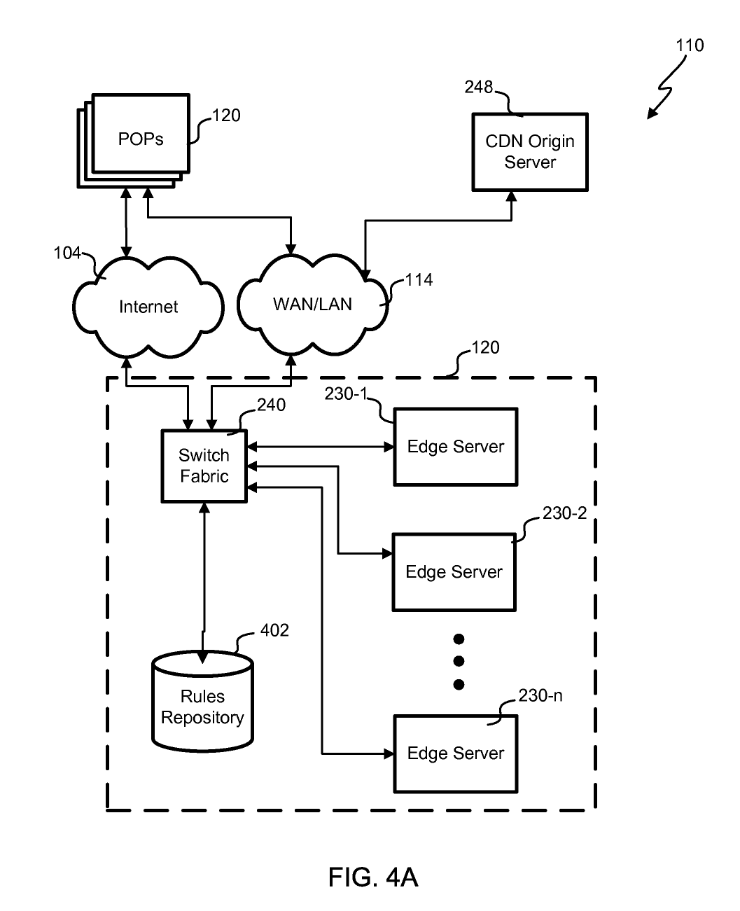

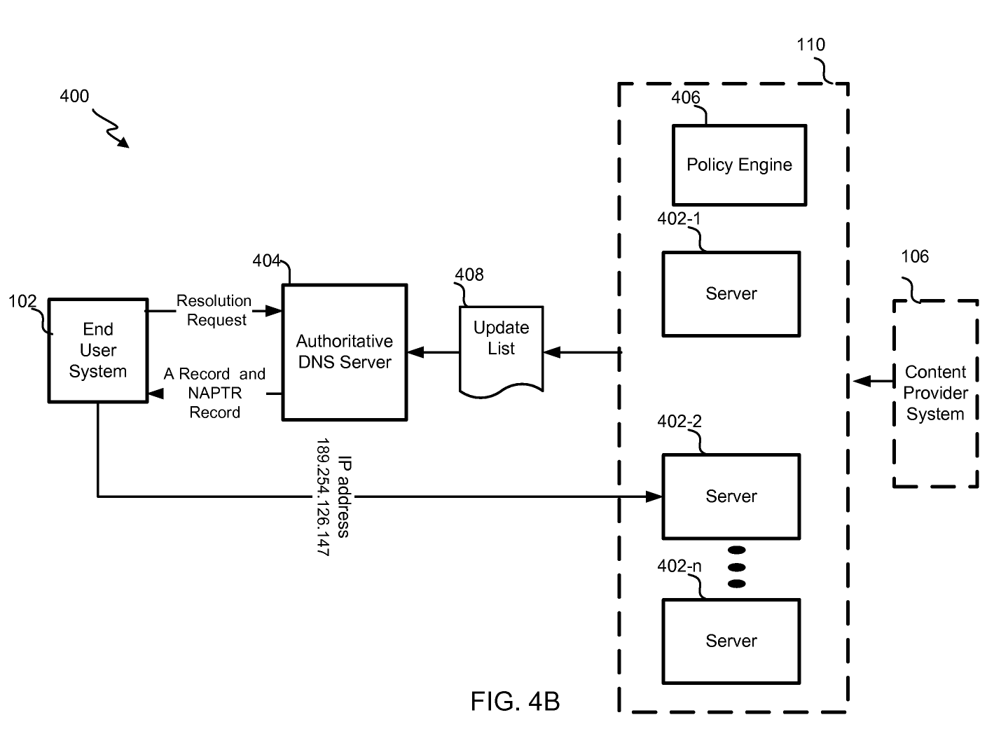

FIG. 4A depicts a block diagram of a POP 120 having a rules repository 402 and a plurality of edge servers 230. Other POPs 120 are shown. In some embodiments, each POP 120 has a rules repository 402. In some embodiments, there is one rules repository for the CDN 110. In some embodiments, the rules repository 402 is outside the CDN 110, such as in a second content delivery network or operated by a third party.

FIG. 4B depicts a block diagram of an embodiment for updating a rules repository a domain name system (DNS). When an end user 128 requests a content object through its respective end-user system 102, the end-user system 102 sends a DNS resolution request. The DNS resolution request is passed, either directly or indirectly, via the Internet to an authoritative DNS server 404. A DNS resolution request is often in the form of a text string for a URL. A DNS resolution request is also referred to as a DNS request. In one example, the DNS resolution request originates from an application on an end-user system 102 that has knowledge of, and can address a DNS resolution request to a specific edge server 230 in the CDN 110 by an Internet Protocol (IP) address of the specific edge server 230.

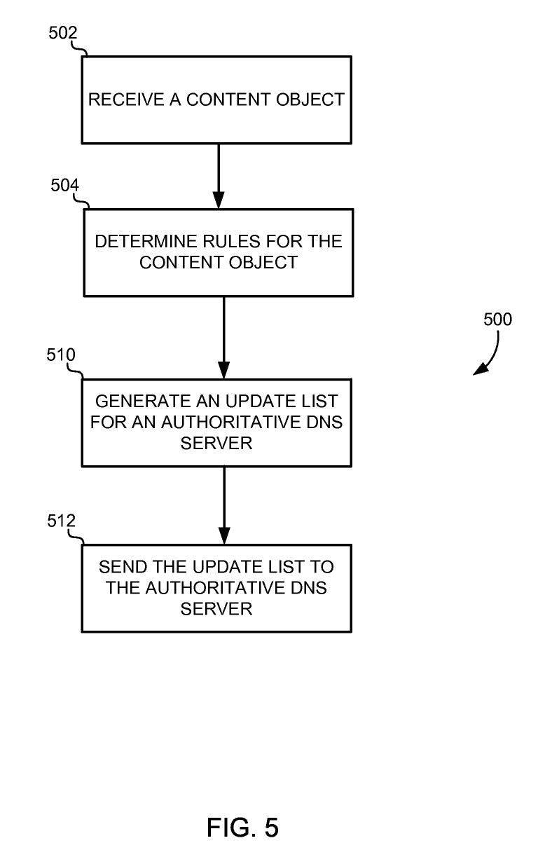

FIG. 5 illustrates a flowchart of a method for updating a DNS for individual content object, according to some embodiments. This method may include the preliminary steps of storing and processing policies that govern how content is stored. The CDN 110 is configured to receive a content object, step 502, and determine one or more policies for the content object, step 504.

In step 510, the policy engine 406 generates an update file 408 of the individual content object for an authoritative DNS server 404 based on the one or more policies. In some embodiments, the update file 408 may include metadata of the individual content object, a unique identifier and/or an arbitrary identifier for one or more policies, information that specifies how to process DNS resolution requests, and/or a status of one or more servers (e.g., server on- or off-line). The update file 408 may be a one or more records, a single executable instruction, and/or a plurality of executable instructions. In step 512, the update file 408 is sent to the authoritative DNS server 404.

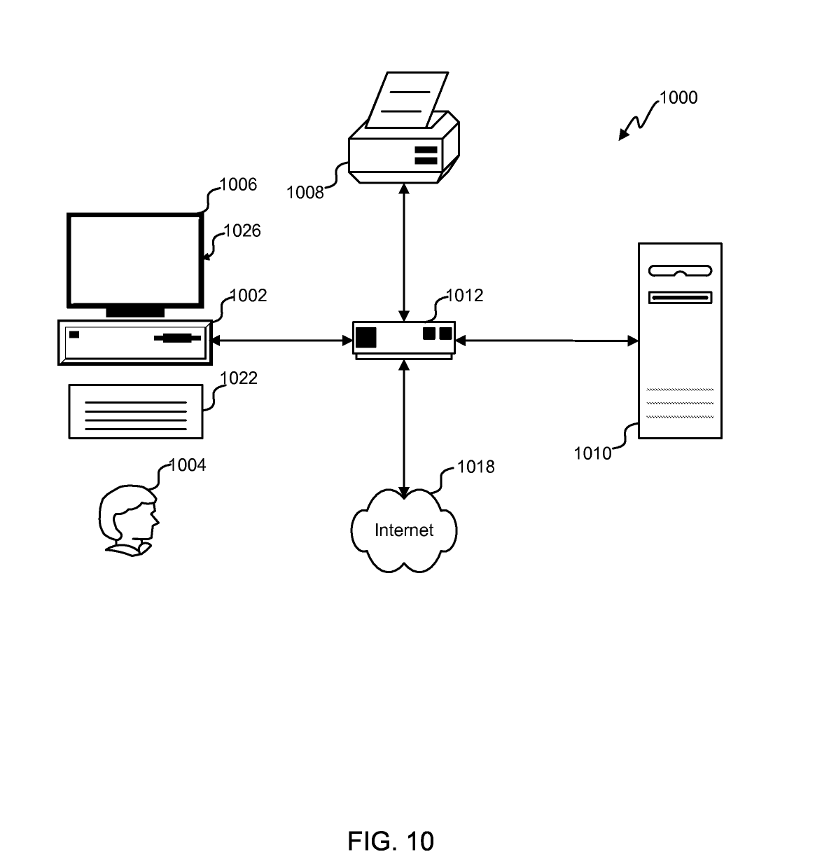

Referring next to FIG. 10, an exemplary environment with which embodiments may be implemented with a computer system 1000 that can be used by a designer 1004 to design, for example, electronic designs. The computer system 1000 can include a computer 1002, keyboard 1022, a network router 1012, a printer 1008, and a monitor 1006. The monitor 1006, processor 1002 and keyboard 1022 are part of a computer system 1026, which can be a laptop computer, desktop computer, handheld computer, mainframe computer, etc. The monitor 1006 can be a CRT, flat screen, etc.

A designer 1004 can input commands into the computer 1002 using various input devices, such as a mouse, keyboard 1022, track ball, touch screen, etc. If the computer system 1000 comprises a mainframe, a designer 1004 can access the computer 1002 using, for example, a terminal or terminal interface. Additionally, the computer system 1026 may be connected to a printer 1008 and a server 1010 using a network router 1012, which may connect to the Internet 1018 or a WAN.

The server 1010 may, for example, be used to store additional software programs and data. In one embodiment, software implementing the systems and methods described herein can be stored on a storage medium in the server 1010. Thus, the software can be run from the storage medium in the server 1010. In another embodiment, software implementing the systems and methods described herein can be stored on a storage medium in the computer 1002. Thus, the software can be run from the storage medium in the computer system 1026. Therefore, in this embodiment, the software can be used whether or not computer 1002 is connected to network router 1012. Printer 1008 may be connected directly to computer 1002, in which case, the computer system 1026 can print whether or not it is connected to network router 1012.

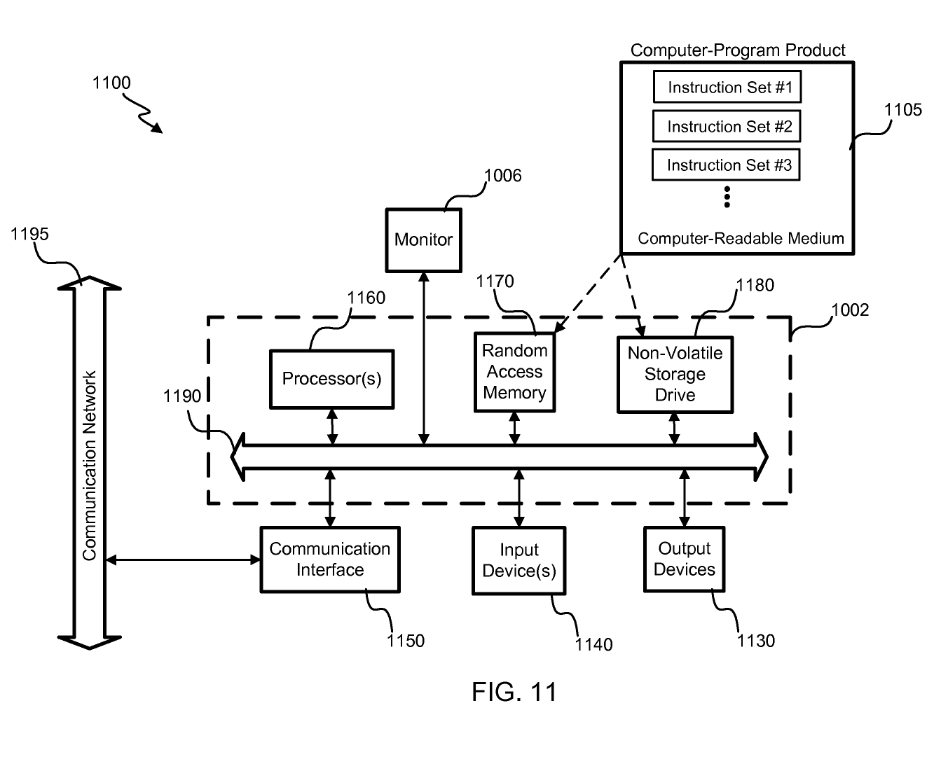

Referring next to FIG. 11, the above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1026, it is transformed into the special-purpose computer system 1100.

Special-purpose computer system 1100 comprises a computer 1002, a monitor 1006 coupled to computer 1002, one or more additional user output devices 1130 (optional) coupled to computer 1002, one or more user input devices 1140 (e.g., keyboard, mouse, track ball, touch screen) coupled to computer 1002, an optional communications interface 1150 coupled to computer 1002, a computer-program product 1105 stored in a tangible computer-readable memory in computer 1002. Computer-program product 1105 directs system 1100 to perform the above-described methods. Computer 1002 may include one or more processors 1160 that communicate with a number of peripheral devices via a bus subsystem 1190. These peripheral devices may include user output device(s) 1130, user input device(s) 1140, communications interface 1150, and a storage subsystem, such as random access memory (RAM) 1170 and non-volatile storage drive 1180 (e.g., disk drive, optical drive, solid state drive), which are forms of tangible computer-readable memory.

Computer-program product 1105 may be stored in non-volatile storage drive 1180 or another computer-readable medium accessible to computer 1002 and loaded into memory 1170. Each processor 1160 may comprise a microprocessor, such as a microprocessor from Intel® or Advanced Micro Devices, Inc.®, or the like. To support computer-program product 1105, the computer 1002 runs an operating system that handles the communications of product 1105 with the above-noted components, as well as the communications between the above-noted components in support of the computer-program product 1105. Exemplary operating systems include Windows® or the like from Microsoft Corporation, Solaris® from Sun Microsystems, LINUX, UNIX, and the like.

User input devices 1140 include all possible types of devices and mechanisms to input information to computer system 1002. These may include a keyboard, a keypad, a mouse, a scanner, a digital drawing pad, a touch screen incorporated into the display, audio input devices such as voice recognition systems, microphones, and other types of input devices. In various embodiments, user input devices 1140 are typically embodied as a computer mouse, a trackball, a track pad, a joystick, wireless remote, a drawing tablet, a voice command system. User input devices 1140 typically allow a user to select objects, icons, text and the like that appear on the monitor 1006 via a command such as a click of a button or the like. User output devices 1130 include all possible types of devices and mechanisms to output information from computer 1002. These may include a display (e.g., monitor 1006), printers, non-visual displays such as audio output devices, etc.

Communications interface 1150 provides an interface to other communication networks and devices and may serve as an interface to receive data from and transmit data to other systems, WANs and/or the Internet 1018. Embodiments of communications interface 1150 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1150 may be coupled to a computer network, to a FireWire® bus, or the like. In other embodiments, communications interface 1150 may be physically integrated on the motherboard of computer 1002, and/or may be a software program, or the like.

RAM 1170 and non-volatile storage drive 1180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1170 and non-volatile storage drive 1180 may be configured to store the basic programming and data constructs that provide the functionality of various embodiments of the present invention, as described above.

Software instruction sets that provide the functionality of the present invention may be stored in RAM 1170 and non-volatile storage drive 1180. These instruction sets or code may be executed by the processor(s) 1160. RAM 1170 and non-volatile storage drive 1180 may also provide a repository to store data and data structures used in accordance with the present invention. RAM 1170 and non-volatile storage drive 1180 may include a number of memories including a main random access memory (RAM) to store of instructions and data during program execution and a read-only memory (ROM) in which fixed instructions are stored. RAM 1170 and non-volatile storage drive 1180 may include a file storage subsystem providing persistent (non-volatile) storage of program and/or data files. RAM 1170 and non-volatile storage drive 1180 may also include removable storage systems, such as removable flash memory.

Bus subsystem 1190 provides a mechanism to allow the various components and subsystems of computer 1002 communicate with each other as intended. Although bus subsystem 1190 is shown schematically as a single bus, alternative embodiments of the bus subsystem may utilize multiple busses or communication paths within the computer 1002.

Specific details are given in the disclosure to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that include or carry instruction(s) and/or data.

While the principles of the disclosure have been described above in connection with specific apparatuses and methods, it is to be clearly understood that this disclosure is made only by way of example and not as limitation on the scope of the disclosure.

1. A method for dynamically responding to domain name system (DNS) requests, the method comprising:
receiving a domain name system (DNS) request, wherein:
the DNS request is received either directly or indirectly from an end-user system; and
the DNS request is to identify an IP address of a server to provide a content object identified by a uniform resource locator (URL);
identifying a first IP address;
identifying a second IP address;
returning a DNS response to the end-user system, wherein:
the DNS response comprises two resource records, an Address record and a Naming Authority Pointer record;
the Address record includes the first IP address;
the Naming Authority Pointer record includes the second IP address;
the end-user system determines whether to use the first IP address or the second IP address to request the content object.

2. The method for dynamically responding to domain name system (DNS) requests as recited in claim 1, wherein:
the first IP address is identified based on a network cost; and
the second IP address is identified without regard to the network cost.

3. A method for dynamically responding to domain name system (DNS) requests, the method comprising:
receiving a domain name system (DNS) request, wherein:
the DNS request is received at a first server in a content delivery network;
the DNS request is received either directly or indirectly from a second server in the content delivery network;
the DNS request is to identify an IP address of a server to provide a content object identified by a uniform resource locator (URL);
identifying a first IP address;
identifying a second IP address;
returning a DNS response to the second server, wherein:
the DNS response comprises two resource records, an Address record and a Naming Authority Pointer record;
the Address record includes the first IP address;
the Naming Authority Pointer record includes:
the second IP address; and
information about a server using the second IP address; and
the second server determines to route the a request for the content object using the second IP address instead of the first IP address based on the information about the server using the second IP address.

4. The method for dynamically responding to domain name system (DNS) requests as recited in claim 3, wherein:
the first IP address is identified based on a network cost; and
the second IP address is identified without regard to the network cost.

5. The method for dynamically responding to domain name system (DNS) requests as recited in claim 4, wherein:
the network cost is based on network or application distance.

6. The method for dynamically responding to domain name system (DNS) requests as recited in claim 4, wherein:
the network cost is based on dollar cost.

7. The method for dynamically responding to domain name system (DNS) requests as recited in claim 4, wherein:
the network cost is based on protocol and availability.

8. A system for dynamically responding to domain name system (DNS) requests, the system comprising:
a content delivery network that receives a DNS request, wherein:
a first server in a content delivery network receives the DNS request;
a second server in the content delivery network receives the DNS request either directly or indirectly;
an IP address of a server identified by the DNS request to provide a content object identified by a uniform resource locator (URL);
the server identifies a first IP address;
the server identifies a second IP address;
the server returns a DNS response to the second server, wherein:
the DNS response comprises two resource records, an Address record and a Naming Authority Pointer record;
the Address record includes the first IP address;
the Naming Authority Pointer record includes:
the second IP address; and
information about a server using the second IP address; and
the second server determines to route the a request for the content object using the second IP address instead of the first IP address based on the information about the server using the second IP address.

9. The system for dynamically responding to domain name system (DNS) requests as recited in claim 8, wherein:
the first IP address is identified based on a network cost; and
the second IP address is identified without regard to the network cost.

10. The system for dynamically responding to domain name system (DNS) requests as recited in claim 9, wherein:
the network cost is based on network or application distance.

11. The system for dynamically responding to domain name system (DNS) requests as recited in claim 9, wherein:
the network cost is based on dollar cost.

12. The system for dynamically responding to domain name system (DNS) requests as recited in claim 9, wherein:
the network cost is based on protocol and availability.

13. A system for dynamically responding to domain name system (DNS) requests, the system comprising:
an end-user system that receives a DNS request, wherein:
the end-user system either directly or indirectly receives the DNS request;
an IP address of a server identified by the DNS request to provide a content object identified by a uniform resource locator (URL);
the server identifies a first IP address;
the server identifies a second IP address;
the server returns a DNS response to the end user system, wherein:
the DNS response comprises two resource records, an Address record and a Naming Authority Pointer record;
the Address record includes the first IP address;
the Naming Authority Pointer record includes:
the second IP address; and
information about a server using the second IP address; and
the end user system determines whether to use the first IP address or the second IP address to request the content object.

14. The method for dynamically responding to domain name system (DNS) requests as recited in claim 13, wherein:
the first IP address is identified based on a network cost; and
the second IP address is identified without regard to the network cost.

15. The method for dynamically responding to domain name system (DNS) requests as recited in claim 14, wherein:
the network cost is based on network or application distance.

16. The method for dynamically responding to domain name system (DNS) requests as recited in claim 14, wherein:
the network cost is based on dollar cost.

17. The method for dynamically responding to domain name system (DNS) requests as recited in claim 14, wherein:
the network cost is based on protocol and availability.

18. The method for dynamically responding to domain name system (DNS) requests as recited in claim 2, wherein:
the network cost is based on network or application distance.

19. The method for dynamically responding to domain name system (DNS) requests as recited in claim 2, wherein:
the network cost is based on dollar cost.

20. The method for dynamically responding to domain name system (DNS) requests as recited in claim 2, wherein:
the network cost is based on protocol and availability.
